(19) United States
(12) Patent Application Publication
(10) Pub. No.: US 2009/0147427 A1
(43) Pub. Date: Jun. 11, 2009

(54) BATTERY DISCONNECT DEVICE

(76) Inventors: Yeshaiahou Aharon Levinas, Key Largo, FL (US); Tamir Levinas, Tel-Aviv (IL); Vladimir Ilitch Demikhovsky, Yavne (IL); Yoav Geva, Moshav Tal-Shahar (IL)

Correspondence Address: GOTTLIEB RACKMAN & REISMAN PC, 270 MADISON AVENUE, 8TH FLOOR, NEW YORK, NY, 10016-0601, US

(21) Appl. No.: 12/236,574

(22) Filed: Sep. 24, 2008

Related U.S. Application Data
(60) Provisional application No. 60/974,610, filed on Sep. 24, 2007.

(51) Int. Cl. H01H 47/00

(52) U.S. Cl. 361/170

(57) ABSTRACT

A battery disconnect device for a motor vehicle and the like includes a housing with a monitor circuit and a sealed relay. The monitoring circuit senses various conditions, such as current drawn from the battery, drop in the battery voltage, engine starting, engine running, and the like and in response operates the relay to insure that the battery does not get damaged or depleted.

### RELATED APPLICATION

This application claims priority to U.S. Provisional application Ser. No. 60/974,610 filed Sep. 24, 2007 and incorporated herein by reference.

### BACKGROUND OF THE INVENTION

A. Field of Invention

This invention pertains to a device which can be installed in a motor vehicle such as an automobile, a truck or a sports utility vehicle. More particularly, the subject invention pertains to a device which automatically disconnects the battery of motor vehicle or other apparatus using batteries such as generators, emergency power systems, solar panels, power generating devices using wind, etc., and selectively reconnects the same on demand.

B. Description of the Prior Art

A critical part of any automotive vehicle is its battery which provides power for various primary and secondary systems. Normally an automotive battery can last for a relatively long time since its charge is refreshed continuously as the vehicle is operated. However, in some instances, such as for example, human error or when a short occurs in the vehicle wiring, or a control switch malfunctions, a leakage current may flow when the engine is off, discharging the battery.

In order to protect the battery from such an occurrence, several proposals have been made for devices that can interrupt undeniable leakage current flow. However, the devices proposed so far have several disadvantageous features which makes them undesirable. One such feature is that they interpose a relatively high series resistance between the battery and the car wiring. Therefore a high IR drop is developed, especially at high current drains, thereby reducing the voltage that is available to the vehicle systems, wasting energy, and generating undesirable heat.

A further disadvantage of the proposed devices is that they may not stand up to the extremely hostile environment existing under the hood of motor vehicles. This environment is characterized by high temperatures as well as corrosive fumes which damage sensitive electronic circuitry.

U.S. Pat. No. 6,424,511 provides a battery disconnect switch that resolves some of the problems mentioned above. However, it does not address other problems related to extreme temperatures (hot or cold), high current drains during the normal operation of the vehicle, as well as using the battery disconnect device to prevent unauthorized use of the vehicle.

### SUMMARY OF THE INVENTION

Briefly, a battery disconnect device for an automotive vehicle includes a control circuit that sense several preselected conditions; connecting elements such as bars connecting said battery to the vehicular equipment; and a relay having a coil and a contact disposed within a closed chamber and associated with the coil. The coil is activated when an abnormal condition is sensed by the control circuit. These conditions may include a current drain on the battery. A manual push button may be used to reset the contact to the closed position.

Additional elements are used to provide other advantageous features. One such element is a remote trip or close circuit which allows the coil to be tripped or closed remotely thereby allowing the device to be used as an antitheft device. The remote close circuit and/or the remote trip circuit could be activated by a switch on the dashboard or a portable transmitter.

The device may further include an indicator for showing when the battery is overcharged, as well as a shunt circuit to allow a trickle current to flow between the battery and the motor vehicle bus for powering certain equipment in the car.

The device may also include an engine sensor that determines when the engine is on or not, based preferably on spurious high frequency signals on the positive bus or connector.

In addition, the device may also include a temperature sensor that senses the ambient temperature and the battery temperature. The voltage and current from the battery may also be sensed. The battery is then disconnected if the ambient temperature is too high or too low, if the battery temperature is too high or too low or if the starting current is too high and/or the starting voltage is too low indicating that the battery is near the end of its useful life.

Additional elements are used to provide other advantageous features. One such element is a remote trip circuit which allows the solenoid to be tripped remotely thereby allowing the device to be used as an antitheft device. In addition to the pushbutton, a remote close circuit may also be used to close the solenoid. The remote close circuit and/or the remote trip circuit could be activated by a portable transmitter.

The device may further include an indicator for showing when the battery is overcharged, as well as a shunt circuit to allow a trickle current to flow between the battery and the motor vehicle bus for powering certain equipment in the car.

### BRIEF DESCRIPTION OF THE DRAWINGS

FIG. 1 shows an orthogonal view of a battery disconnect device constructed in accordance with this invention;

FIG. 2 shows a block diagram for the control system used to operate the subject disconnect device; and

FIG. 3 shows a timing diagram for the operation of the apparatus of FIGS. 2 and 3.

### DETAILED DESCRIPTION OF THE INVENTION

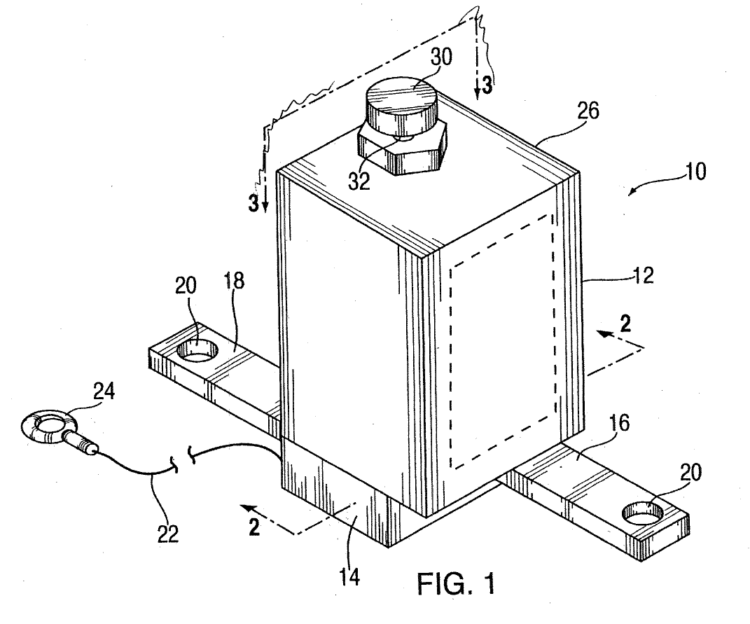

Referring now to FIG. 1, a battery disconnect device 10 constructed in accordance with this invention includes a housing 12 with a base 14, an input bar 16 and an output bar 18. Each bar is provided with a corresponding hole 20 for connecting the positive cable device 10 between the battery and of a motor vehicle. Also attached to the housing 12 is a grounding wire 22 terminating with an eyelet 24. The eyelet 24 is connected to the engine block (not shown) or other negative terminals. Housing 12 further includes a non-conductive shell 26 attached to the base 14 and forming a cavity for the various additional elements of the device 10. A pushbutton 28 extends outwardly of shell 26 on a shaft 30.

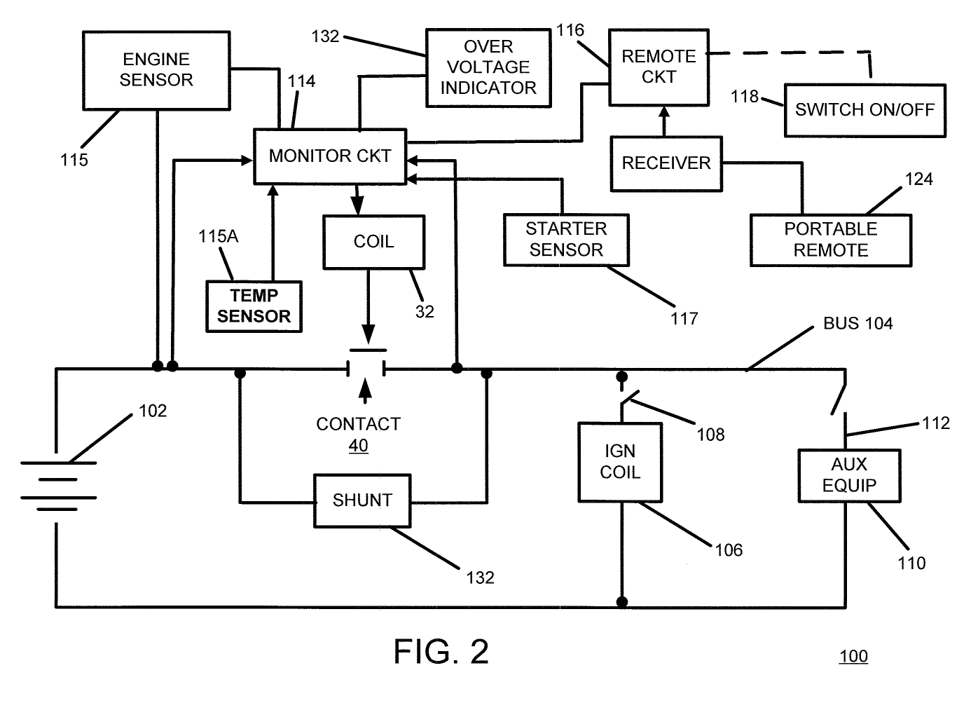

Referring now to FIG. 2, typically the electrical circuitry 100 of an automotive vehicle includes a rechargeable battery 102 which feeds a battery bus 104. An ignition coil 106 is selectively energized by bus 104 through a switch 108. The alternator used to charge the battery, and many well know standard automotive components have been omitted for the sake of clarity. Other auxiliary equipment (such as a starter, spark plugs, and many other elements) collectively identified by numeral 110 are selectively energized by a respective switch 112. Importantly, bus 104 is selectively connected to battery 102 by an electronic switch such as a relay in response to commands from a control circuit 113. The relay includes an electromagnetic coil 32 and a normally open contact 40 (that is, a contact that is open when coil 32 is energized) operating as discussed below.

The control circuit 113 is physically mounted in housing 12 on a standard PC board (not shown). The control circuit 113 includes a monitor circuit 114. This monitor circuit 114 performs several functions. One of its functions is to sense the battery voltage and/or monitors current flowing from the battery, and is used to sense an abnormal condition. For example, if switch 112 is defective, it may remain turned on and maintain some leakage current through the auxiliary equipment 110 even after the engine is turned off. If the driver leaves the vehicle and is not aware of this problem, after some time, the current through the auxiliary equipment 110 drains the battery 102 sufficiently so that when the driver returns he will not be able to start his engine. With the present invention, this leakage current is detected (either from a voltage drop on the battery 102, or by actually measuring the current from the battery) and the coil 32 is energized thereby opening the contact 40. Details of a preferred embodiment of the relay are found in commonly owned U.S. Pat. No. 6,424,511 incorporated herein by reference.

Preferably, the monitor circuit 114 is also connected to an engine sensor circuit 115. This engine sensor circuit 115 detects whether the engine of the vehicle is on or off. If the engine is on, the monitor circuit 114 is disabled as discussed in more detail below to insure that a large current flow or other normal signal is not misinterpreted by the control circuit 113 as an abnormal signal.

The engine sensor circuit 115 can be implemented using various techniques. In one embodiment, the engine sensor circuit senses high frequency signals on the bus 104 using, for example a high pass filter (not shown) tuned to the timing of the engine. Various types of engines are associated with various types of signals. For example, in an internal combustion engine, high frequency signals are generated whenever a spark plug or an injection valve is activated. These signals cause very distinctive spikes in the range of about 50 mv and a frequency of 80+pulses/sec on the bus 104 and are easily detected.

The monitor circuit 114 is further associated with a starter sensor 117. The starter sensor 117 detects a sudden short voltage drop indicating that the starter is energized. For example, for each starter activation, the voltage on the battery may drop below 8 VDC in 1 msec. If such a drop is detected, the starter sensor disables the circuit 114 for a short period, e.g. 3 seconds.

In one embodiment, a remote circuit 116 is provided. This circuit 116 may be used to sense the position of an on/off switch 118 hardwired to another part of the vehicle, such as, for example, on the dash board. When the switch 118 is one position, for example, closed, the remote circuit 116 requests the monitor circuit 114 to open the contact 40. When the switch 118 is opened, the contact 40 is closed by the monitor circuit 114.

In addition, or instead of switch 118, a portable remote control unit 124 may also be provided that is carried by the driver. The control circuit 113 includes a receiver 122 that is in communication with (or at least receives signals from) a portable remote control 124. Preferably, the remote control 124 has one or more momentary switches (not shown) and the receiver circuit 122 senses when these switches are momentarily activated and sends appropriate commands to the remote circuit 116. The control circuit 113 then operates the coil 32 accordingly. In one embodiment, the communication between the remote transmitter and the receiver 122 is encoded using a unique security key. In other words, the transmitter 124 and receiver 122 can communicate only when they share a security key. Therefore the remote transmitter 124 can be used as an antitheft device because the driver can activate coil 32 remotely thereby disabling the vehicle. The vehicle then cannot be started without deactivating the coil 32 through monitor circuit 114. The switch 118 may also be used as a theft deterrent.

The elements of control circuit 113 are being shown as discrete elements for the sake of clarity. However, it should be understood that preferably, the control circuit 113 is implemented by a microprocessor and software to perform the described functions.

Another feature that may be added to the circuitry 100 is an electrical close circuit 120. This electrical close circuit 120 may include another coil disposed within the housing of device 10 and arranged so that when it is activated, it pulls rod 70 away from sleeve 62 and cause it to snap to the closed position. Electrical close circuit 120 may be activated by a manual pushbutton on housing 12, not shown, or may be activated by a remote close circuit 122.

Since the monitor circuit monitors the condition of the battery 102 anyway, it may also be used to detect an overcharge condition. If, for example, the sense/trip circuit 114 detects when the voltage of battery 102 is over a predetermined value, such as 13.8V, the sense/trip circuit generates an over voltage signal OV. This signal OV is used to drive an over voltage indication 132. This indicator 132 may be disposed on the housing 12, or it may be disposed remotely, for example on the dash board.

The circuitry 100 may be also provided with a shunt circuit 130. This circuit 130 is designed to allow a current of a predetermined value (which is relatively low as compared for example to the current used during ignition). This circuit 130 may be used to allow some of the auxiliary equipment 108 to get power from the bus 104 even if the solenoid is open, as long as this equipment does not draw too much current. The various circuits used to control the operation of the subject solenoid can be implemented by using a microprocessor to reduce power requests and size.

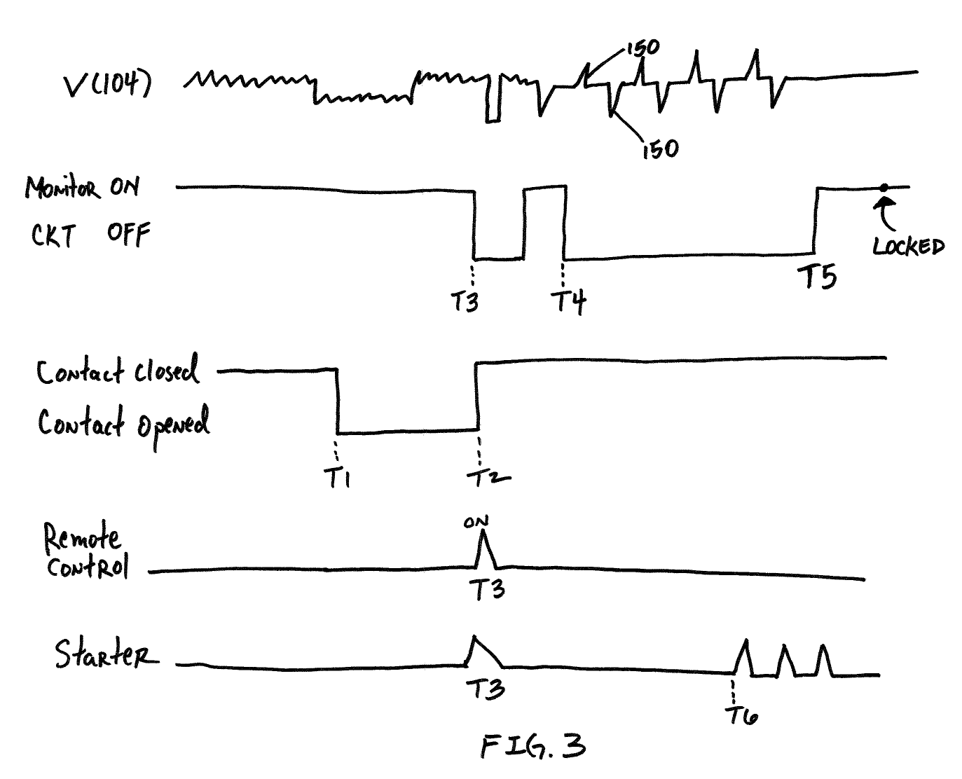

The operation of the control circuit 113 is now described in conjunction with the timing diagram of FIG. 3. Initially, the engine of the motor vehicle is off and the voltage of battery 102 and bus 104 is nominal with a slight ripple caused by noise. The monitor circuit 114 is on, the relay coil 32 is off and the contact 40 is closed. At t=T1 an undesirable leakage current causes the voltage on bus 104 to drop below a threshold. This drop is sensed by the monitor circuit 114 which, in turn, energizes the coil 32 causing the contact 40 to open. At t=T2 the leakage current disappears. The monitor circuit 114 de-energizes the coil 32 and the contact 40 returns to its closed position.

In another embodiment, the solenoid 32 is closed manually, using a pushbutton 30.

Sometime later, at t=T3 the driver approaches the car and activates the portable remote 124 or switch 118 control (if used). He then activates the starter (not shown). This action causes the voltage and current to flow to the engine and is detected by the starter sensor 117. Accordingly, the monitor circuit 114 is deactivated for the next 3 seconds. Meanwhile, the internal engine starts and this causes various signals 150 to appear on bus 104. At t=T4 these signals are detected by engine sensor 115 thereby causing the monitor circuit 114 to be disabled while the engine is on.

Sometime later at t=T5 the driver turns the engine off and walks away from it. The engine sensor circuit 115 activates circuit 116. At t=T6 a thief enters the car and activates the starter. The car will not start because the contact 40 is opened and there is insufficient current to turn the engine over. But if the monitor circuit 114 detects this action, and if the thief tries the starter three times, the monitor circuit 114 locks up and will only operate normally if it is reset from the portable remote 124.

In one embodiment of the invention, the circuit 100 also includes a temperature sensor 115A that senses the temperature of the battery 102 and/or the ambient temperate (in the engine compartment). If these temperatures are too high or too low the contact 40 is opened to insure that the battery is not damaged.

In yet another embodiment, when the engine is started the voltage and on the battery bus or the current from the battery is monitored. A low current or a high voltage drop during starting may indicate that the battery is depleted or it is near the end of its useful life and the contact 40 is opened.

The various elements in FIG. 2 are shown and described as discrete elements for the sake of clarity however it should be understood that they can be combined into a single analog/digital electronic circuit using standard IC techniques.

Obviously, numerous modifications may be made to the invention without departing from its scope as defined in the appended claims.

We claim:

1. A battery disconnect device for an engine with a battery comprising:
an engine sensor that senses when the engine is on and generating a corresponding engine signal;
a monitor circuit that senses a preselected condition of the battery and receiving said engine signal; and
an electronic switch operated by said monitor circuit, said monitor circuit selectively operating said electronic switch dependent on said preselected condition, said monitor circuit being disabled when said engine is on.

2. The device if claim 1 further comprising a temperature sensor generating a temperature signal indicative of one of an ambient and a battery temperature, said monitor circuit receiving said temperature signal and selectively activating said electronic switch when said temperature is above or below some threshold values.

3. The device of claim 1 further comprising a starter sensor that detects when said engine is started, wherein said monitor circuit is disabled while said engine is started.

4. The device of claim 1 wherein said monitor circuit detects when the current from said battery is within a predetermined range when the engine is off and, in response, opens said electronic switch.

5. The device of claim 1 further comprising a receiver receiving external command signals, said monitor circuit receiving said commands from said receiver and operating said electronic switch in response.

6. The device of claim 5 further comprising a remote switch, generating said commands.

7. The device of claim 5 further comprising a wireless remote generating said commands.

8. The device of claim 7 wherein said receiver and said wireless remote communicate using encoded communication signals and are paired so that a wireless remote from another device will not operate the receiver.

9. The device of claim 1 wherein said monitor circuit measures an output from said battery and opens said electronic switch if said output indicates that the battery is depleted.

10. A battery disconnect device for an engine with a battery and a starter for selectively starting said engine comprising:
a monitor circuit that senses a preselected condition of the battery and receiving an engine signal;
an electronic switch operated by said monitor circuit, said monitor circuit selectively operating said electronic switch dependent on said preselected condition; and
a starting sensor that determines when the starter is starting said engine, said starting sensor selectively disabling said monitor circuit when said engine is started.

11. The battery disconnect device of claim 10 wherein said battery is connected to said engine by a battery bus and said starting sensor monitors signals on said battery bus to determine the engine starting.

12. The battery disconnect device if claim 11 wherein said starting sensor detects said starting as a signal on said battery bus having predetermined characteristics.

13. A battery disconnect device for an engine with a battery and a battery bus connecting said engine and said battery, comprising:
an engine sensor connected to said battery bus to sense when the engine is on and generating a corresponding engine signal;
a monitor circuit that senses a preselected condition of the battery and receiving said engine signal; and
an electronic switch operated by said monitor circuit, said monitor circuit selectively operating said electronic switch dependent on said preselected condition, said monitor circuit being disabled when said engine is on.

14. The battery disconnect device of claim 13 wherein said battery bus carries signals having specific characteristics when the engine is on and said engine sensing circuit senses said signals.

15. The battery disconnect device of claim 13 wherein said electronic switch is a relay with an electromagnetic coil selectively energized by said monitor circuit, and a contact operated by said coil to selectively connect said battery to said engine.

16. The battery disconnect device of claim 15 wherein said contact is open when said coil is energized.
